(19) United States
(12) Patent Application Publication
(10) Pub. No.: US 2008/0076377 A1
(43) Pub. Date: Mar. 27, 2008

(54) SATELLITE HIGH-FREQUENCY RECEIVER CIRCUIT, CIRCUIT SYSTEM FOR PROCESSING SATELLITE SIGNALS, AND METHOD FOR OPERATING SUCH A CIRCUIT SYSTEM

(76) Inventors: Hans-Joachim Golberg, Ulm (DE); Holger Schulz, Erbach (DE)

Correspondence Address: MG-IP Law, PLLC, P.O. BOX 1364, FAIRFAX, VA, 22038-1364, US

(21) Appl. No.: 11/861,266

(22) Filed: Sep. 25, 2007

Related U.S. Application Data
(60) Provisional application No. 60/847,123, filed on Sep. 26, 2006.

(30) Foreign Application Priority Data
Sep. 25, 2006 (DE) DE 102006045542

(51) Int. Cl. H04B 1/28

(52) U.S. Cl. 455/333

(57) ABSTRACT

A satellite high-frequency receiver circuit, circuit system for processing satellite signals, and method for operating such a circuit system is provided. The satellite high-frequency receiver circuit for processing satellite signals, includes at least one integrated control circuit which is designed for in-circuit provision or disconnection of a supply voltage, a circuit system for processing satellite signals using a satellite high-frequency receiver circuit for editing the satellite signal, and a satellite signal evaluation circuit for analyzing the edited satellite signal for providing a position signal and/or time signal and/or speed signal, and a method for operating such a circuit system. According to the invention, the satellite high-frequency receiver circuit and/or the satellite signal evaluation circuit have at least one integrated supply terminal which is designed to provide at least one supply voltage to allow at least one discretely designed electronic component provided in the circuit system to be supplied.

This nonprovisional application claims priority to German Patent Application No. DE 102006045542, which was filed in Germany on Sep. 25, 2006, and to U.S. Provisional Application No. 60/847,123, which was filed on Sep. 26, 2006, and which are both herein incorporated by reference.

### BACKGROUND OF THE INVENTION

1. Field of the Invention

The present invention relates to a satellite high-frequency receiver circuit for processing satellite signals, comprising at least one integrated control circuit which is designed for in-circuit provision or disconnection of a supply voltage, a circuit system for processing satellite signals using a satellite high-frequency receiver circuit for editing the satellite signal, and a satellite signal evaluation circuit for analyzing the edited satellite signal for providing a position signal and/or time signal and/or speed signal, and a method for operating such a circuit system.

2. Description of the Background Art

A conventional circuit system is designed for the processing of high-frequency electromagnetic satellite signals emitted by satellites in an earth orbit. The circuit system is installed, for example, in a receiver for a global positioning system (global positioning system receiver or GPS receiver). The purpose of the circuit system is essentially to process the coded signals from the satellites in such a way that position signal and/or time signal and/or speed signals may be provided for further processing, for example by a navigation system. Since the satellite signals are typically very weak, amplification by means of a low-noise amplifier (LNA) is generally provided for feeding the coded signals to the circuit system.

The amplified satellite signal is used as an input signal for a satellite high-frequency receiver circuit, also referred to a radio frequency semiconductor component or RF chip. The frequency of the satellite signal, which is set at approximately 1.5 GHz, is typically reduced to approximately 100 MHz in the satellite high-frequency receiver circuit. Intermediate frequency filtering and amplification in an adjustable amplifier stage are then performed. In a final step the frequency of the signal is reduced once again and the signal is digitized. The satellite high-frequency receiver circuit relays the digitized signal to the satellite signal evaluation circuit, in which speed and/or time and/or position data are computed from the edited satellite signal by means of a clock signal provided by an external oscillator. These data are then transmitted to a computer in the GPS system for further processing.

The conventional circuit unit is designed in such a way that the satellite high-frequency receiver circuit and the satellite signal evaluation circuit may be placed in an operating state or in a neutral state via an internal or external activation signal. In the operating state the satellite signals may be edited and evaluated, which requires a considerable quantity of electrical energy, and which for mobile GPS systems is typically provided by a continuous energy storage element such as a battery or accumulator. In contrast, no signal editing or evaluation occurs in the neutral state, thus allowing the electrical power demand of the satellite high-frequency receiver circuit and of the satellite signal evaluation circuit to be significantly reduced, thereby conserving the capacity of the energy storage element. Capability for switching off the power supply to additional components of the circuit unit is provided in order to further reduce the electrical power demand of the circuit unit. For this purpose, the known circuit unit has a supply circuit, composed of discrete electronic components, which is controlled by the activation signal and is able to provide or disconnect a supply voltage for the additional components of the circuit unit as a function of a signal level of the activation signal.

### SUMMARY OF THE INVENTION

It is therefore an object of the present invention to provide a satellite high-frequency receiver circuit, a circuit unit, and a method for operating such a circuit unit which allow power to be supplied to discrete components in a simplified manner.

According to an aspect of the invention, a satellite high-frequency receiver circuit can be provided for editing satellite signals by means of at least one integrated control circuit which is designed for in-circuit provision or disconnection of a supply voltage, at least one integrated supply terminal being provided which is designed to provide the supply voltage to at least one external electronic component. The satellite high-frequency receiver circuit contains the internal activation circuit, which as a function of an internal or external activation signal provides an internal supply voltage and thus allows operation of the satellite high-frequency receiver circuit. According to the invention, the satellite high-frequency receiver circuit has an integrated supply terminal, i.e., implemented as a component of the circuit realized as an integrated circuit on a semiconductor component. This supply terminal is able to provide electrical power to a discrete component, i.e., a component that is implemented separately from the satellite high-frequency receiver circuit. In contrast to known satellite high-frequency receiver circuits, not only is it possible to provide a logical control signal for controlling a supply circuit, composed of discrete electronic components, for the external component, but the supply terminal is also able to directly supply the external, discrete component with electrical power. This allows the circuitry design in which the satellite high-frequency receiver circuit is provided to be greatly simplified, since further discrete electronic components for switching the supply voltage for the external components on or off may be omitted.

In a further aspect of the invention, an activation signal terminal which is designed for transmitting an external activation signal to the control circuit can be associated with the integrated control circuit. This allows an external activation signal to be fed to the satellite high-frequency receiver circuit. Thus, no intrinsic, internal circuit is required for determining when the supply voltage must be switched on or off in order to save energy and thus conserve the capacity of the energy storage element. Instead, by use of the external activation signal the switching on and off of the internal power supply as well as the switching on and off of the supply voltage may both be achieved at the supply terminal.

In a further design of the invention, the control circuit for the internal and external provision of the supply voltage can be designed as a function of the activation signal. This allows the shared use of important parts of the control circuit for the internal provision of the supply voltage as well as for provision of the supply voltage at the supply terminal. Despite the additional supply terminal, this common use allows the design of the satellite high-frequency receiver circuit to be kept simple and the surface to be enlarged only slightly, if necessary.

According to another aspect of the invention, a circuit unit of the aforementioned type can be provided in which the satellite high-frequency receiver circuit and/or the satellite signal evaluation circuit have at least one integrated supply terminal which is designed for providing at least one supply voltage to allow at least one discretely designed electronic component provided in the circuit system to be supplied. The integrated supply terminal is designed in such a way that it is able to directly provide the electrical power for supplying one or more discrete components provided in the circuit system without the intermediate switching of further electronic components. The supply terminal is implemented on the satellite high-frequency receiver circuit which is designed as a semiconductor component, or on the satellite signal evaluation circuit which is designed as a semiconductor component, in the form of a connecting surface or a plurality of connecting surfaces. In this manner, providing a supply circuit composed of discrete electronic components for supplying the discrete components may be omitted. This allows the space requirements for the circuit unit to be reduced, and ensures a simplified design for the circuit system. This is particularly the case when the semiconductor components of the satellite high-frequency receiver circuit and of the satellite signal evaluation circuit are connected to one another in a planar configuration as a multichip module and accommodated in a common housing.

In one design of the invention, a control circuit integrated into the satellite high-frequency receiver circuit and/or into the satellite signal evaluation circuit is associated with the supply terminal. The purpose of the control circuit is to provide the supply voltage for the discrete component as a function of the activation signal at the supply terminal. For this purpose the semiconductor component of the satellite high-frequency receiver circuit or of the satellite signal evaluation circuit may be provided with a transistor or a transistor system which preferably is composed of PMOS transistors or NMOS transistors. A threshold switch, which in particular is designed as a Schmitt trigger, may be provided for controlling the transistor or transistor system. At least one inverter or one inverter system is connected between the threshold switch and the transistor or transistor system to allow the activation signal, which is relayed to the transistor or transistor system when a threshold voltage specified by the Schmitt trigger is exceeded, to advantageously be adapted to the requirements of the transistor or transistor system.

In a further design of the invention, the at least one electronic component is designed as a low-noise amplifier or as a temperature-compensated quartz oscillator, and is free of an internal control circuit for providing a supply voltage. Such discrete components are typically not provided with their own integrated control circuit for providing a supply voltage. An internal control circuit entails the risk of transmission of interferences which may impair the signal quality of a low-noise amplifier or the quality of a clocked signal from the quartz oscillator. Such discrete components thus require an external control circuit if their supply voltage is to be shut off in a neutral state without having to shut off the supply voltage for the entire circuit system.

In a further design of the invention, the control circuit is designed to provide a supply voltage which has a voltage level that is different from a voltage level of the activation signal. The activation signal is a logical signal for which neither the voltage level nor the current intensity to be provided is suitable for ensuring a direct supply to the discrete component. By use of the control circuit, when the activation signal is present it is possible to connect a supply voltage whose voltage level is much higher than the voltage level of the activation signal. By way of example, a value for the activation signal can be 1.8 volts, and for the supply voltage, 3.3 volts.

In a further design of the invention, the control circuit is designed to provide the supply voltage to the integrated supply terminal and also to provide an internal operating voltage, in particular identical to the supply voltage, for the satellite high-frequency receiver circuit or the satellite signal evaluation circuit. As a result of the integration according to the invention of the control circuit into the satellite high-frequency receiver circuit or the satellite signal evaluation circuit, the circuit parts which are necessary for providing the internal operating voltage may also be used to provide the supply voltage to the supply terminal. This double use of the corresponding circuit parts results in simplification and a particularly compact design of the corresponding semiconductor component, which may also result in cost savings during manufacture.

According to a further aspect of the invention, a method is provided for operating a circuit comprising the following steps: generation of an activation signal by the satellite signal evaluation circuit; provision of the activation signal to the satellite high-frequency receiver circuit; enabling of the supply voltage to the satellite high-frequency receiver circuit as a function of the activation signal resulting from the control circuit; enabling of the supply voltage to the integrated supply terminal as a function of the activation signal resulting from the control circuit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a circuit system provided for use in a satellite navigation system;

FIG. 2 shows a detailed illustration of the circuit system according to FIG. 1; and

FIG. 3 shows an exemplary embodiment of a control circuit for providing a supply voltage.

### DETAILED DESCRIPTION

FIG. 1 schematically illustrates a GPS receiver unit 10 provided for the reception of signals from a plurality of satellites 12 through 18 which are on different earth orbits. The satellites 12 through 18 emit coded signals which may be distinguished from one another, and which typically are transmitted at a frequency of 1575 GHz and which may be received by an antenna 20 of the GPS receiver unit 10. The antenna 20 is connected to a low-noise amplifier (LNA) 22 which amplifies the weak signals from the satellites 12 through 18 and which is designed so that it causes little or no degradation of the signal-to-noise ratio of the satellite signal. The amplified satellite signal is filtered by use of a surface acoustic wave filter or SAW filter 24 which acts as a band-pass filter, and is then relayed as an input signal for a circuit system designed as a receiver multichip module 26.

The receiver multichip module 26 has a radio frequency semiconductor component or RF chip 30, also referred to as a GPS front-end IC, which is designed as a satellite high-frequency receiver circuit for editing the satellite signal. Also provided on the receiver multichip module 26 is a digital semiconductor component (also referred to as a digital chip 32 or a GPS baseband IC), designed as a satellite signal evaluation circuit, for analyzing the edited satellite signal for providing a position signal and/or time signal and/or speed signal and which further processes the edited satellite signal.

After the processing in the digital chip 32, an output signal 28 is provided by the receiver multichip module 26; the output signal may be provided for further processing by electronic circuits (not illustrated). The output signal 28 may contain in particular information concerning position and/or time and/or speed, which is obtained from the various signals from the satellites 12 through 18 by means of the GPS receiver unit 10.

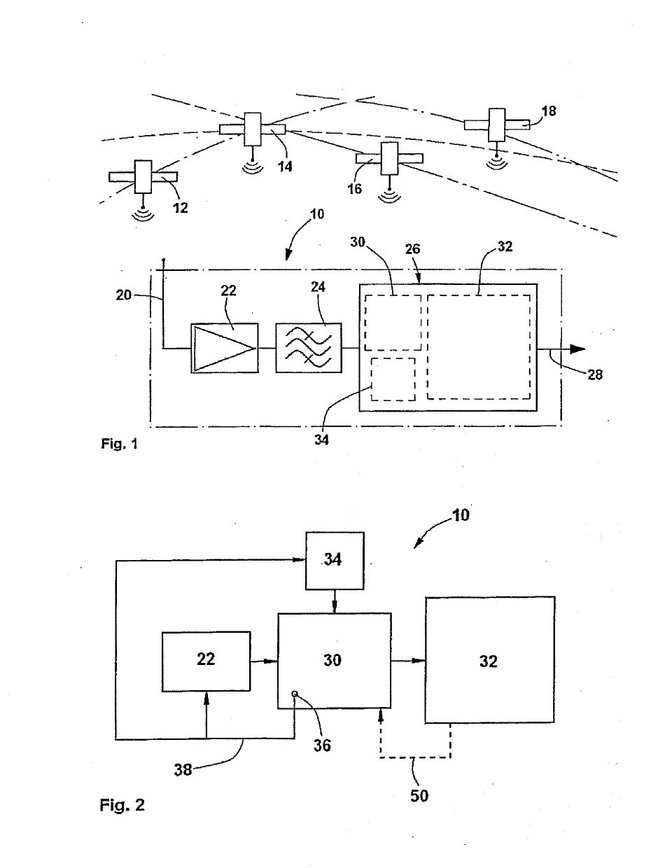

As illustrated in greater detail in FIG. 2, in the GPS receiver unit 10 the signal is transmitted from the LNA 22 to the RF chip 30, and from there to the digital chip 32. A temperature-compensated quartz oscillator or TCXO 34 likewise transmits a signal to the RF chip 32. In addition, an activation signal is transmitted via an activation line 50 from the digital chip 32 to an activation signal terminal (not described in greater detail) of the RF chip 30. The RF chip has a supply terminal 36 for providing a supply voltage. A supply line 38 runs from the supply terminal 36 to the LNA 22 and to the TCXO 34. The supply voltage provided by the supply terminal 36 is directly provided to the LNA 22 and the TCXO 34 via the supply line 38, without intermediately connected electronic components.

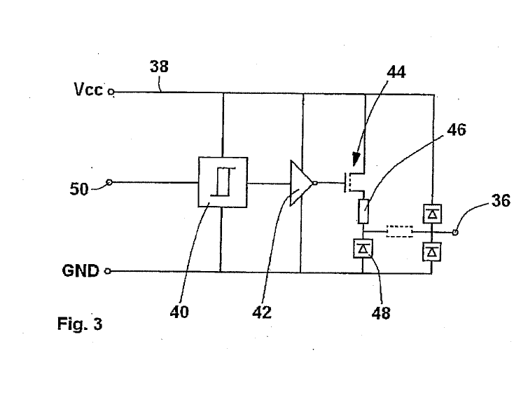

The control circuit schematically illustrated in FIG. 3 is a section of a much more complex circuit which is implemented on the RF chip 30 designed as a semiconductor component. The control circuit comprises a threshold switch designed as a Schmitt trigger 40 and an inverter 42, illustrated as an example, connected downstream. These circuit parts are provided on the RF chip 30 anyway to allow the circuit parts (not illustrated in greater detail) of the RF chip 30 to be supplied with the supply voltage Vcc. An activation signal typically present as a logical “high” may be provided at the Schmitt trigger 40 via the activation line 50. After a specifiable switching threshold is exceeded, the Schmitt trigger 40 relays the activation signal to the inverter 42. The inverter 42 emits an inverted activation signal to a downstream PMOS transistor 44 which is thus able to provide the supply voltage Vcc at the supply terminal 36. Associated with the PMOS transistor 44 are a protective resistor 46 as short-circuit and ESD protection and a protective diode 48 which are designed to prevent destruction of the control circuit upon improper connection to an external voltage, or from electrostatic discharges (ESD). Provided between the supply terminal 36 and the PMOS transistor 44 connected thereto are two additional protective diodes (not described in greater detail) which are provided for diverting electrostatic discharges and which are coupled to the ground potential GND or to the supply voltage. A line resistor, not described in greater detail, is illustrated as a dotted line between the supply terminal 36 and the protective resistor 46 or the protective diode 48.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A satellite high-frequency receiver circuit for editing satellite signals, the circuit comprising at least one integrated control circuit that is designed for in-circuit provision or disconnection of a supply voltage, the at least one integrated supply terminal being provided for providing the supply voltage to at least one external electronic component.

2. The satellite high-frequency receiver circuit according to claim 1, wherein an activation signal terminal is associated with the integrated control circuit and is designed for transmitting an external activation signal to the control circuit.

3. The satellite high-frequency receiver circuit according to claim 2, wherein the control circuit for an internal and external provision of the supply voltage is designed as a function of the activation signal.

4. A circuit system for processing satellite signals, the circuit comprising:
a satellite high-frequency receiver circuit for editing the satellite signal; and
a satellite signal evaluation circuit for providing a position signal and/or time signal and/or speed signal,
wherein the satellite high-frequency receiver circuit and/or the satellite signal evaluation circuit have at least one integrated supply terminal that is designed to provide at least one supply voltage to allow at least one discretely designed electronic component provided in the circuit system to be supplied.

5. The circuit system according to claim 4, wherein a control circuit integrated into the satellite high-frequency receiver circuit and/or into the satellite signal evaluation circuit is associated with the supply terminal.

6. The circuit system according to claim 4, wherein the at least one electronic component is a low-noise amplifier or a temperature-compensated quartz oscillator, and is free of an internal control circuit for providing a supply voltage.

7. The circuit system according to claim 5, wherein the control circuit is designed for providing a supply voltage which has a voltage level that is different from a voltage level of the activation signal.

8. The circuit system according to claim 5, wherein the control circuit is designed to provide the supply voltage to the integrated supply terminal and also to provide an internal operating voltage, in particular identical to the supply voltage, for the satellite high-frequency receiver circuit or the satellite signal evaluation circuit.

9. A method for operating a circuit system comprising:
generating an activation signal by a satellite signal evaluation circuit;
providing the activation signal to a satellite high-frequency receiver circuit;
enabling the supply voltage for the satellite high-frequency receiver circuit as a function of the activation signal resulting from the control circuit; and
enabling the supply voltage to the integrated supply terminal as a function of the activation signal resulting from the control circuit.
